(19) United States
(12) Patent Application Publication
(10) Pub. No.: US 2018/0120240 A1
(43) Pub. Date: May 3, 2018

(54) Deep Water Radiography

(71) Applicant: Varex Imaging Corporation, Salt Lake City, UT (US)

(72) Inventors: Gongyin Chen, Henderson, NV (US); Robert E. Drubka, Las Vegas, NV (US); John Stammetti, Las Vegas, NV (US); Charles Stirm, Henderson, NV (US)

(21) Appl. No.: 15/337,422

(22) Filed: Oct. 28, 2016

(51) Int. Cl. G01N 23/04; G01N 23/18

(52) U.S. Cl. CPC G01N 23/04; G01N 2223/3103; G01N 2223/628; G01N 23/18

(57) ABSTRACT

An apparatus having a submersible, hollow, closed container and an x-ray imaging system radiation source disposed within that container. The submersible container is configured to withstand at least 10 atmospheric pressure (atm) and hence to withstand being submerged at least 100 meters (m) in a liquid (such as an open body of water) without undergoing permanent deformation. The x-ray imaging system radiation source intern is configured to selectively direct x-rays towards an object under inspection that is external to the submersible container. Detector components can be similarly placed within the aforementioned container or within one or more additional such containers.

### BACKGROUND

Deep water oil and gas pipes are an important means of transporting oil and natural gas. Such pipes are built to withstand high internal pressures as well as high external hydrostatic pressures. For example, at a depth of 3 km, a deep water pipe must withstand more than 300 times atmospheric pressure.

Many deep water pipes are between 400 mm and 600 mm in diameter and have a steel wall with a thickness ranging from 20 mm to 35 mm. Many deep water pipes also have a thermal insulation layer to prevent oil from waxing in the pipe (and hence constricting flow), a steel coating for the insulator, and also a cement protective layer.

Over time, erosion and corrosion may develop both inside and outside the deep water pipe. Any of the aforementioned layers may become cracked and threaten the integrity of the deep water pipe.

X-ray radiography is a known method to conduct inspection of large objects for cracks and the like. X-ray systems are used, for example, to inspect cargo, engine blocks, and even rocket engines. Unfortunately, the various components that comprise a typical x-ray imaging system are configured and designed to operate on land in an open air environment and are not well suited to the multiple significant challenges presented in a deep-water setting.

### BRIEF DESCRIPTION OF THE DRAWINGS

The above needs are at least partially met through provision of the method and apparatus for facilitating deep water radiography described in the following detailed description, particularly when studied in conjunction with the drawings, wherein:

FIG. 1 comprises a side elevational block diagram view of an x-ray imaging system as configured in accordance with various embodiments of these teachings;

FIG. 2 comprises a block diagram view of a submersible radiation source as configured in accordance with various embodiments of these teachings;

FIG. 3 comprises a block diagram view of a submersible radiation detector as configured in accordance with various embodiments of these teachings;

FIG. 4 comprises a block diagram view of a submersible radiation source as configured in accordance with various embodiments of these teachings;

FIG. 5 comprises a side elevational block diagram detail view of a submersible radiation source as configured in accordance with various embodiments of these teachings;

FIG. 6 comprises a side elevational block diagram view of an x-ray imaging system as configured in accordance with various embodiments of these teachings;

FIG. 7 comprises a side elevational block diagram view of an x-ray imaging system as configured in accordance with various embodiments of the invention; and

FIG. 8 comprises a flow diagram as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in radiography except where different specific meanings have otherwise been set forth herein.

### DETAILED DESCRIPTION

This disclosure relates generally to radiography and more specifically to radiography of a submersed object. Generally speaking, the various embodiments described herein provide an apparatus having a submersible, hollow, closed container and an x-ray imaging system radiation source disposed within that container. For a typical application setting the submersible container is configured to withstand at least an external pressure of 150 standard atmospheres (atm) which permits submerging the container to at least 10 meters (m) and also to a depth of at least 1.5 kilometers (km) in a liquid (such as an open body of water) without undergoing permanent deformation. (One standard atmosphere can also be represented as 9.8692×10⁻⁶ Pascals (Pa), 0.9678411 bars, or 6.8046×10⁻² pounds per square inch (psi).) The x-ray imaging system radiation source is configured to selectively direct x-rays towards an object under inspection that is external to the submersible container. Such an object may be disposed, for example, upon (or within) a sea bed or deep lakebed.

By one approach at least one thermal management component can be included to dissipate heat generated by the x-ray imaging system radiation source. By one approach this thermal management component comprises heat fins that are thermally coupled to the submersible hollow and closed container such that at least some heat generated by the x-ray imaging system radiation source is conducted via the heat fins to the surrounding open body of water.

By another approach, in lieu of the foregoing or in combination therewith, the at least one thermal management component can include a selectively circulating liquid coolant that moves heat from at least a part of the x-ray imaging system radiation source to a wall of the container and then to the surrounding open body of water.

By one approach the submersible hollow and closed container is formed at least in part of steel and has an at least substantially convex shape (such as a spherical shape or an ellipsoidal shape). By one approach, the container also includes a relatively small concave portion configured to accommodate a cylindrically-shaped object (such as a deep water pipe) under inspection in close proximity. In addition, the container can be filled with an essentially oxygen-free gas such as nitrogen gas.

By one approach the aforementioned submersible hollow and closed container also houses the x-ray detector components that are configured to detect x-rays that pass through the object under inspection. By another approach, the apparatus includes a second submersible hollow and closed container that includes the x-ray detector components.

By one approach, in a typical application setting a power source and at least some control circuitry is disposed on a surface platform (such as a surface ship or an oil drilling platform) and/or in a remotely operated underwater vehicle (ROV).

So configured, the x-ray imaging system radiation source and its corresponding detector components can be safely submerged to the deep water location of an object, such as a deep water pipe, to be examined with x-ray imaging. Such an apparatus makes possible the use of known examination techniques in an application setting that has been, to date, hostile to such methodologies.

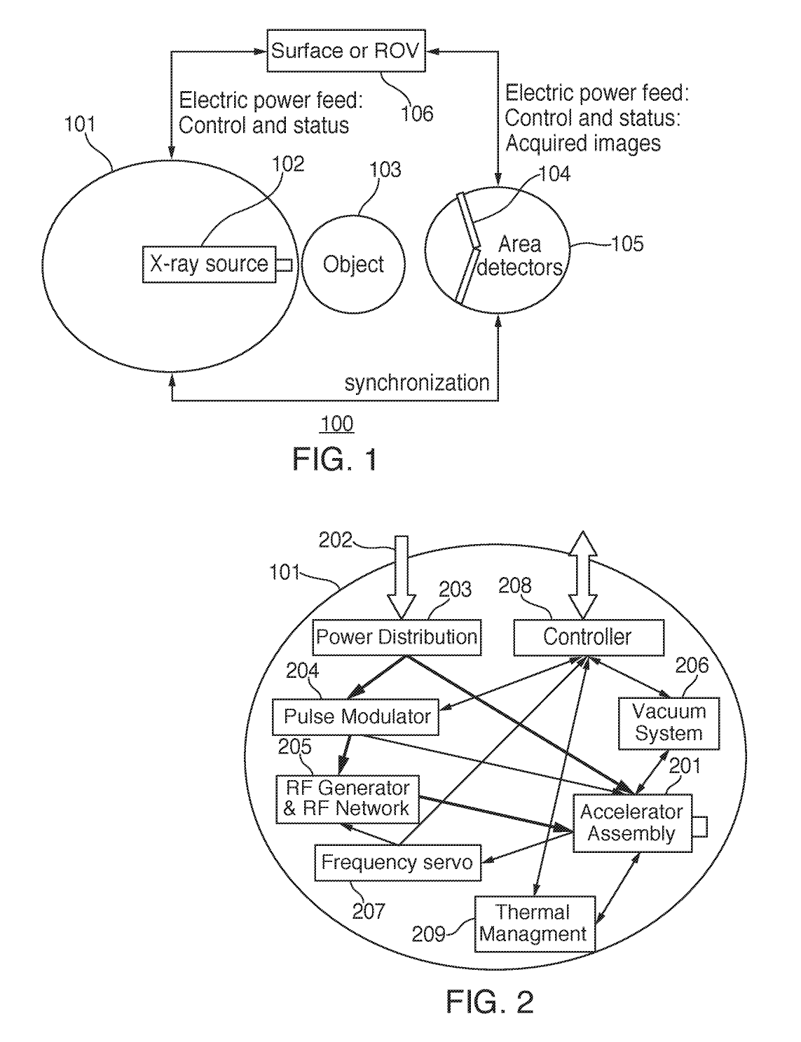

These and other benefits may become clearer upon making a thorough review and study of the following detailed description. Referring now to the drawings, FIG. 1 presents an apparatus 100 that includes a submersible hollow and closed container 101 (“container”) that is configured to be submerged at least 1.5 km in an open body of water without undergoing permanent deformation that would otherwise occur due to external pressures, temperature, corrosive influences, and so forth at that depth and as may correspond to a given application setting. Depending upon anticipated needs the accommodated depth can vary. For example, the container 101 may be configured to serve as described at depths up to 3 km (having a typical corresponding pressure of 300 atm), 4 km (having a typical corresponding pressure of 400 atm), 5 km (having a typical corresponding pressure of 500 atm), 6 km (having a typical corresponding pressure of 600 atm), and so forth as desired. Every 10 meters of water depth adds approximately 1 atm of pressure. So configured, it will be appreciated that the container 101 can also serve in a satisfactory manner at shallower depths (such as 1 m, 3 m, 10 m, 100 m, or the like, having a typical corresponding pressure of 0.1 atm, 0.3 atm, 1 atm, or 10 atm respectively).

The container 101 can be at least substantially formed of steel, titanium, acrylic resins, or some other suitably strong material, including composite materials (such as metal matrix composites (MMC) and reinforced plastics or polymer matrix composites (PMC0)). The steel can include high-strength alloyed steel or stainless steel, which is resistant to corrosion. By one approach the container 101 has an at least substantially convex shape (where the expression “substantially” will be understood to refer to at least 80 percent surface area). By one approach the container 101 is generally symmetrical in shape and may comprise, for example, a sphere or an ellipsoid. That said, these teachings will readily accommodate nonsymmetrical shapes as desired.

X-rays are a type of ionizing radiation. Accordingly, when x-rays interact with ordinary air the interaction produces a significant amount of ozone (especially in front of the x-ray source head). Generally speaking, each 100 electron volts (eV) of radiation energy that interacts with pure oxygen produces approximately 13 ozone molecules while each 100 eV of radiation energy that interacts with ordinary air produces approximately 7 to 10 ozone molecules. Ozone is a strong oxidant. Unfortunately, as little as one part per million ozone concentration can lead to significant material degradation and/or oxidation that results in damaged equipment, hoses, and/or cables. With the foregoing in mind, by one approach the container 101 is filled with an essentially oxygen-free gas (0.1% oxygen or less), such as nitrogen gas (where commercially-available nitrogen gas usually has less than 2 parts per million (ppm) of oxygen and less than 2 ppm water). In another example, essentially oxygen-free gas is less than 0.01% oxygen. By one approach the internal atmospheric pressure is regulated to around 1.0 atm (for example, within 1%, 2%, 3%, 4%, or 5% as desired) to accommodate the design specifications of typical x-ray equipment. For example, internal atmospheric pressure can be between 0.99 atm and 1.01 atm, 0.98 atm and 1.02 atm, 0.97 atm and 1.03 atm, and 0.96 atm and 1.04 atm, or 0.95 atm and 1.053 atm. In an example, the internal atmospheric pressure is regulated by a pressure regulator (not shown).

Using dry nitrogen gas provides another benefit as well; internal humidity problems are essentially eliminated. As a result, essentially no condensation within the container 101 occurs as the container 101 raises and lowers within an open body of water and experiences corresponding significant changes in temperature.

By one approach the container 101 can also include some flotation components (not shown) affixed, for example, to an upper surface thereof. For many application settings it will be useful if the overall weight of the container 101 and its contents approximate that of the volume of water that the container 101 displaces so the container 101 can be raised and lowered efficiently in the water. The center of gravity can be separate from and, for example, lower than the center of flotation for increased stability. Such design concerns are understood in the art and require no further elaboration here. In another approach the container 101 can be moved by an underwater propulsion or navigation system (not shown). Such underwater propulsion or navigation systems are understood in the art and require no further elaboration here.

The container 101 has an x-ray imaging system radiation source 102 (“x-ray source”) disposed therein. This x-ray source 102 is generally configured to selectively direct x-rays towards an object 103 under inspection that is external to the container 101. The x-ray source 102 can comprise, for example, a radio-frequency (RF) linear particle accelerator-based (linac-based) x-ray source, such as the Varian Linatron M9. The linac is a type of particle accelerator that greatly increases the kinetic energy of charged subatomic particles or ions by subjecting the charged particles to a series of oscillating electric potentials along a linear beamline, which can be used to generate ionizing radiation (e.g., X-rays) and high energy electrons.

For the sake of an illustrative example this description presumes that the object 103 comprises a deep water pipe, a deep water pipe valve, a deep water blowout preventer, or the like. It will be understood that no particular limitations are intended in these regards and that the described apparatus 100 may be successfully deployed with other underwater objects of choice.

FIG. 2 presents a more detailed view of the possible contents of the container 101. In this example the x-ray source 102 includes an accelerator assembly 201. This accelerator assembly 201 includes the electron source (often referred to as an “electron gun”), RF cavities (which are typically operated in a vacuum as maintained by a vacuum system 206), and a conversion target. The electron source injects electrons to be accelerated and the RF cavities bunch and accelerate the electrons to a desired energy level. The accelerated electrons hit the conversion target to produce x-rays in a dipole radiation process called Bremsstrahlung. These aspects of an x-ray source are known in the art and require no further description here.

A power distribution component 203 distributes power received from externally-provided electrical power 202 to this accelerator assembly 201 and to a pulse modulator 204. (The power distribution component 203 can distribute electrical power as appropriate to the other components as well, though FIG. 2 does not present this architecture for the sake of simplicity.)

The pulse modulator 204 generates narrow high-voltage and high power electric pulses. These pulses typically represent several kilowatts (kW) of average power and several megawatts (MW) of peak power during each pulse period of a few microseconds. Pulse repetition frequency is usually a few hundred pulses per second.

The pulse modulator 204 provides these pulses to an RF generator and RF network 205. The RF generator converts the pulsed electric power into RF power for the same duration (e.g., a few microseconds). The RF network delivers the RF power to the accelerator assembly 201 to power the aforementioned electron acceleration. The RF generator can comprise, for example, a magnetron or alternatively a solid-state oscillator followed by a klystron. The magnetron is a high-powered oscillator that can use, for example, a vacuum tube that can generate microwaves using the interaction of a stream of electrons with a magnetic field while moving past a series of open metal cavities (also referred to as cavity resonators or RF cavities). By another approach a solid-state oscillator uses a solid state circuit to produce high quality small signals that can then be amplified by a solid state amplifier. The klystron is a high-power amplifier such as a high RF amplifier (e.g., microwave amplifier), where an electron beam generated by an electron gun interacts with radio waves as the electron beam passes through cavity resonators (or RF cavities) along a length of a tube (e.g., drift tube).

The power distribution component 203 and/or the pulse modulator 204 can provide power to the electron source as comprises a part of the accelerator assembly 201 as described above. A frequency servo 207 can serve to sense changes in resonance frequency of the RF cavities and adjust the RF generator frequency accordingly. Additional components, such as coils to generate a magnetic field for various purposes, may also be included depending on system design.

A controller 208 operably couples to many (or all) of the aforementioned elements and serves to coordinate the actions of these various components. This controller 208 can also serve to communicate with appropriate external elements as desired. By one approach the controller 208 comprises a control circuit and therefore comprises structure that includes at least one (and typically many) electrically-conductive paths (such as paths comprised of a conductive metal, such as copper or silver) that convey electricity in an ordered manner, which path(s) will also typically include corresponding electrical components (both passive (such as resistors and capacitors) and active (such as any of a variety of semiconductor-based devices, like transistors and diodes) as appropriate) to permit the circuit to effect the control aspect of these teachings.

Such a control circuit can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit is configured (for example, by using corresponding programming as will be well understood by those skilled in the art) to carry out one or more of the steps, actions, and/or functions described herein.

By one approach the control circuit operably couples to a memory. This memory may be integral to the control circuit or can be physically discrete (in whole or in part) from the control circuit as desired. This memory can also be local with respect to the control circuit (where, for example, both share a common circuit board, chassis, power supply, and/or housing) or can be partially or wholly remote with respect to the control circuit (where, for example, the memory is physically located in another facility, metropolitan area, or even country as compared to the control circuit).

This memory can serve, for example, to non-transitorily store the computer instructions that, when executed by the control circuit, cause the control circuit to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM), random-access memory (RAM; e.g., static or dynamic RAM), or non-volatile RAM (NVRAM) or flash memory).

A typical x-ray imaging system can consume a high level of electrical power and can generate almost as much corresponding heat. Some components of the system (such as, for example, the aforementioned RF cavities and an RF circulator that can comprise a part of the aforementioned RF network) are typically designed to work at a constant temperature. Accordingly, the container 101 can also include a thermal management system 209 to manage the heat and control the temperature of components within the container 101. Further examples and descriptions in these regards are provided further below.

The interior (and/or exterior) of the container 101 may include some x-ray shielding. For example, x-ray shielding in the backward direction can serve to protect sensitive electronics.

It would be possible, of course, to disperse some of the above-described components amongst a plurality of such containers. While there may be some benefit in some application settings to such an architecture, consolidating these components within a single container helps to minimize the need for additional or excessive cabling (including high-voltage cables) to thereby reduce the need for openings through the container wall and additional high-voltage cables between such containers that may increase risk and contribute to deployment challenges.

Referring again to FIG. 1, this apparatus 100 can also provide x-ray detector components such as, in this example, the area detectors 104. One useful example in these regards comprises a digital area detector (such as an amorphous silicon thin film transistor (TFT) imaging panel) such as the Varian PaxScan series flat panel detector. In other examples, the switching elements of the digital area detector can include charge coupled devices (CCDs), complementary metal-oxide-semiconductor (CMOS) transistors, metal oxide transistors, or transistors made of other semiconductor materials, and/or switching diodes. In this example the x-ray detector components are disposed within a second submersible hollow and closed container 105. (The same enabling details provided above for the first-described container 101 are applicable here for this second submersible hollow and closed container 105 as well, but will not be repeated for the sake of brevity.) Generally speaking, the x-ray detector components are configured to detect x-rays that pass through the object 103 under inspection. Such detectors often employ scintillation material, such as cadmium tungstate (CWO) or cesium iodide (CsI), to detect x-rays and use a corresponding light sensor array to record corresponding scintillator output.

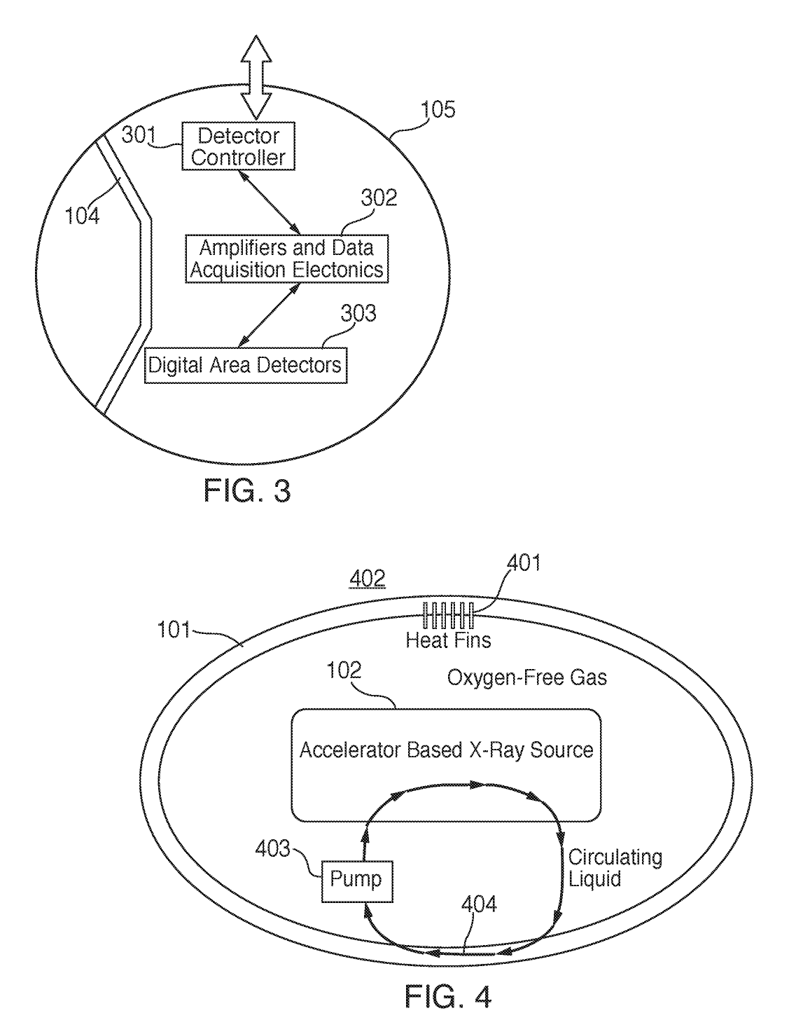

FIG. 3 provides a more detailed example in these regards. In this example a detector controller 301 controls amplifiers and data acquisition electronics 302 that in turn work in conjunction with the corresponding digital array detectors or digital area detector 303. The detector controller 301 can also communicate with a remote operator (for example, to transmit information regarding acquired images) and/or the aforementioned x-ray source 102 (for example, to facilitate synchronization between the source and the detectors).

Referring again to FIG. 1, one or more of the above-described components can be physically, electrically, and/or communicatively coupled to a power source and/or a control circuit that are disposed on a surface platform (such as a boat, ship, or oil drilling platform) or on a remotely operated underwater vehicle (ROV) 106. Such a control circuit can serve, for example, to direct the apparatus 100 to the object 103 and to control the apparatus's use of x-rays to examine the object 103.

As mentioned above, the apparatus 100 can include a thermal management mechanism 209. By one approach the thermal management mechanism 209 can include one or more thermal sensors to provide temperature information regarding a local component or local ambient area. Various thermal sensors are known in the art. Accordingly, further elaboration in these regards is not provided here.

FIG. 4 presents an example where the thermal management approach includes a thermal management component (or passive thermal management component) comprising heat fins 401. These heat fins 401 are thermally coupled to the container 101 such that at least some heat generated by the x-ray source 102 is conducted via the heat fins 401 and the container wall to the surrounding open body of water 402. The temperature of deep sea water can be, for example, 4° Centigrade (C.) and therefore provide a powerful heat sink for the heat fins 401. If desired, one or more fans (not shown) can be included to improve the efficiency of this cooling methodology. These teachings will also accommodate, in lieu of the foregoing or in combination therewith, locating heat fins on the exterior side of the container 101.

FIG. 4 also illustrates the use of an active thermal management component, such as a pump 403 that circulates a liquid coolant, such as deionized or distilled water (e.g., with a conductivity of less than 1.5 millisiemens per meter (mS/m), less than 100 microsiemens per meter (μS/m), or less than 10 μS/m) or diol or glycol (e.g., ethylene glycol, diethylene glycol, or propylene glycol), to move heat from at least a part of the x-ray imaging system radiation source to a wall of the container 101 and then to the surrounding open body of water 402. Impurities, metals, and/or minerals in water used as a coolant can increase the conductivity of the water. Pure distilled water is nonconductive. Many accelerator components that require cooling have built in pipes to accommodate such a liquid coolant. By this approach the wall of the container 101 can also include a coolant circulation pipe (or pipes) 404 to facilitate the desired transfer of heat from the x-ray source 102 to the open body of water 402. A pump pressure of around six times atmospheric pressure (i.e., 6 atm) will typically suffice in these regards.

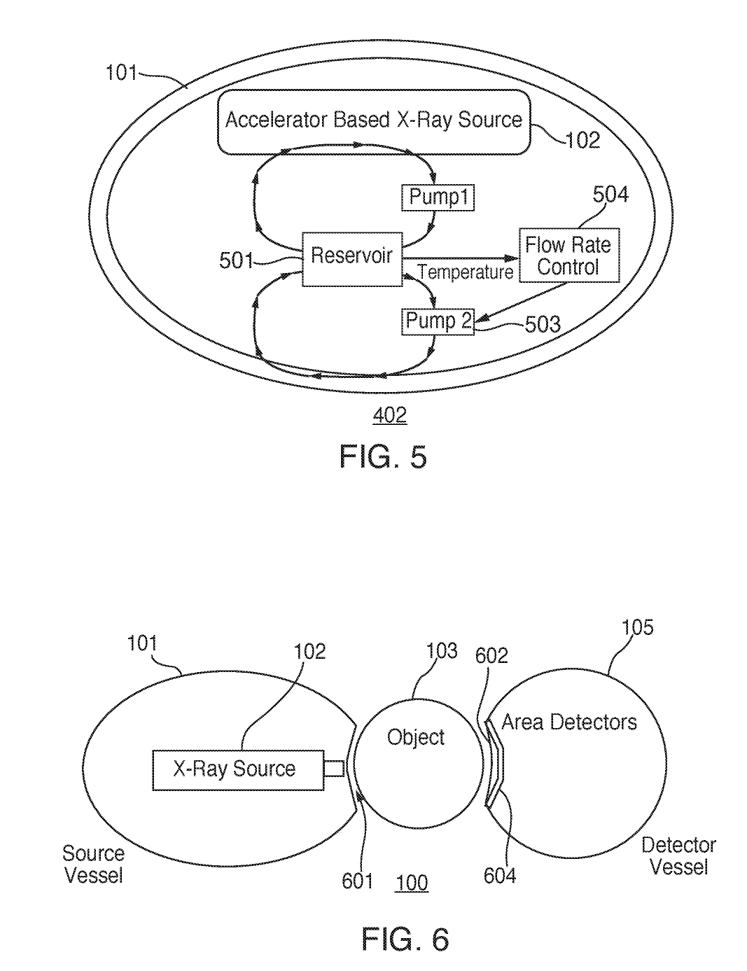

FIG. 5 provides another illustrative approach in these regards. In this example the apparatus 100 includes a reservoir 501 of liquid coolant. This reservoir may have, for example, around 40 liters (L) of capacity. A first pump 502 circulates the liquid coolant through the desired portions of the x-ray source 102. A second pump 503 circulates the liquid coolant through pipes 404 in the wall of the container 101.

In this example a control circuit 504 providing flow rate control serves to actively maintain, for example, the temperature of at least a part of the x-ray source 102 within a predetermined temperature range (such as, for example, +/−1° C.). If desired, one or more flow rate sensors (not shown) can be appropriately located to provide flow rate information to the control circuit 504. In the wall loop, the rate of heat being transferred from the circulating liquid to the container wall is determined by dQ/dt=h*ΔT*A where the heat transfer coefficient h is determined by the turbulence condition (which is in turn determined by material properties, geometry, and flow rate), ΔT represents the difference between wall temperature and the temperature of the bulk liquid, and A represents the contact area between the wall and the circulating liquid. By one approach ΔT would be 26° C. in normal operation when the temperature-sensitive RF components are designed to operate at 30° C. So configured, and based on measured reservoir temperature, the flow rate control circuit 504 can increase or decrease pump flow rates in real time to adjust the amount of heat released into the container wall (and hence the surrounding body of water 402) to thereby maintain the temperature of interest within a small range even without directly measuring that temperature of interest.

As noted above, the object 103 being examined can comprise a pipe. A pipe, of course, has a circular cross-section. If desired, and as shown in FIG. 6, one or both of the containers 101 and 105 can include a relatively small concave portion (601 and 602, respectively) to accommodate a cylindrically-shaped object 103 such as a pipe. (The expression “relatively small” will be understood to refer to an amount that is less than 20 percent of the whole.) In particular, such a container can be placed in close proximity to the object (where the expression “close proximity” will be understood to be a distance less than 30 cm, such as, for example, 20 cm, 10 cm, 5 cm, or the like).

So configured, such a submersible hollow and closed container 101 having an x-ray imaging system radiation source 102 disposed therein can be submersed to a desired depth (such as 1.5 km, 3 km, and so forth) in an open body of water to within some desired distance (such as within at least 0.5 m or less of a submersed object 103) and the radiation source 102 employed to selectively direct x-rays towards the submersed object 103 under inspection. A submersed x-ray detector 104 can be disposed on an opposite side of the object 103 and employed to detect the x-rays to thereby facilitate imaging the object 103.

By one approach the x-ray source 102 and the detectors 104 in their respective containers 101 and 105 can be independently navigated into the aforementioned respective positions (using, for example, on-board or outboard cameras, sonar, or the like). By another approach these two containers 101 and 105 can be physically coupled to one another via a beam or other structure. Such an intervening structure may be rigid and have a fixed length or can be arranged to have a selectively modified length as desired to thereby accommodate variously sized objects.

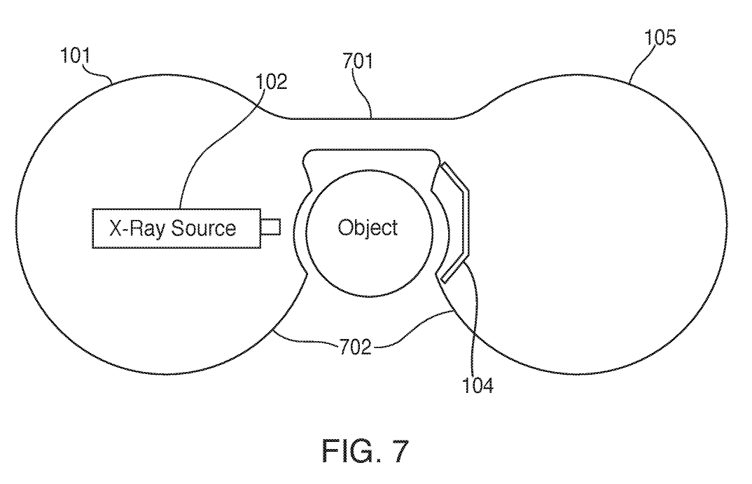

As yet another example in these regards, FIG. 7 presents an approach where the two aforementioned containers 101 and 105 are physically and pneumatically coupled via a bridging member 701 (which may be wholly or partially rigid and/or flexible as desired). So configured, the two above-described containers 101 and 105 are each a part of a same overall submersible hollow and closed container 702. In another example, containers 101 and 105 are coupled or tethered together via a control arm or bridging member with separate chambers.

These teachings will accommodate a wide range of methodologies for delivering the above-described components to the object 103 and/or for properly disposing these components with respect to the object 103. For example, these components can each have an independent capability to deliver and position itself or can be delivered and/or positioned by an external mechanism such as a properly-configured ROV.

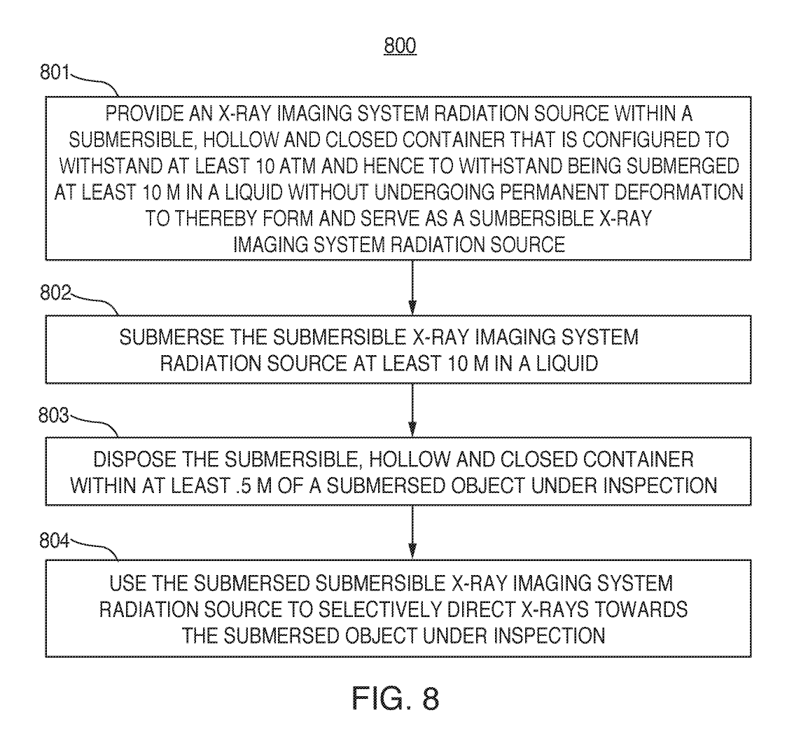

FIG. 8 provides one illustrative example in these regards. Pursuant to this process 800, at block 801 an x-ray imaging system radiation source within a submersible, hollow, closed container as described above that is configured to withstand at least 10 atm and hence to withstand being submerged at least 10 m in a liquid (such as an open body of water) without undergoing permanent deformation as described herein is provided to serve as a submersible x-ray imaging system radiation source.

At block 802 this submersible x-ray imaging system radiation source is submersed at least 10 m in a liquid (such as an open body of water) and, at block 803, is disposed within at least 0.5 m of a submersed object (such as a pipe, valve, or blow-out preventer) under inspection. At block 804 the submersed submersible x-ray imaging system radiation source is then used to selectively direct x-rays towards that submersed object under inspection.

Also-submersed detectors can serve in combination with the submersed submersible x-ray imaging system radiation source to detect such x-rays and thereby provide imaging information regarding the submersed object under inspection.

Depending upon the configuration of the aforementioned components, the system can be used in a same way and considerably greater pressures (such as 150 atm) to thereby obtain image information for objects that are submersed at considerably greater depths (such as 150 m).

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
a submersible, hollow, closed container configured to withstand at least 10 standard atmospheres (atm) of pressure and hence to withstand being submerged at least 100 meters (m) in a liquid without undergoing permanent deformation;
an x-ray imaging system radiation source disposed within the submersible, hollow, closed container and configured to selectively direct x-rays towards an object under inspection that is external to the submersible, hollow, closed container.

2. The apparatus of claim 1 wherein the submersible, hollow, closed container is formed of steel.

3. The apparatus of claim 1 wherein the submersible, hollow, closed container has an at least substantially convex shape.

4. The apparatus of claim 3 wherein the submersible, hollow, closed container has a relatively small concave portion to accommodate a cylindrically-shaped object under inspection in close proximity.

5. The apparatus of claim 1 wherein the submersible, hollow, closed container is filled with an essentially oxygen-free gas.

6. The apparatus of claim 5 wherein the essentially oxygen-free gas essentially consists of nitrogen gas.

7. The apparatus of claim 1 further comprising:
at least one thermal management component to dissipate heat generated by the x-ray imaging system radiation source.

8. The apparatus of claim 7 wherein the at least one thermal management component includes heat fins that are thermally coupled to the submersible, hollow, closed container such that at least some heat generated by the x-ray imaging system radiation source is conducted via the heat fins to the surrounding open body of water.

9. The apparatus of claim 7 wherein the at least one thermal management component selectively circulates a liquid coolant to move heat from at least a part of the x-ray imaging system radiation source to a wall of the submersible, hollow, closed container and then the heat is dissipated to the surrounding open body of water.

10. The apparatus of claim 9 wherein the at least one thermal management component includes a reservoir of the liquid coolant, and wherein the at least one thermal management component is configured to actively maintain at least a part of the x-ray imaging system radiation source within a predetermined temperature range.

11. The apparatus of claim 1 further comprising:
x-ray detector components configured to detect x-rays that pass through the object under inspection.

12. The apparatus of claim 11 wherein the x-ray detector components are disposed within the submersible, hollow, closed container.

13. The apparatus of claim 11 further comprising:
a second submersible, hollow, closed container;
wherein the x-ray detector components are disposed within the second submersible, hollow, closed container.

14. The apparatus of claim 1 further comprising:
a power source and control circuit configured to provide operating power and control instructions to the x-ray imaging system radiation source, wherein the power source and control circuit is disposed external to the submersible, hollow, closed container.

15. The apparatus of claim 14 wherein the power source and control circuit is disposed on a surface platform.

16. The apparatus of claim 14 wherein the power source in control circuit is disposed on a remotely operated underwater vehicle (ROV).

17. The apparatus of claim 1 wherein the submersible, hollow, closed container is configured to withstand at least 150 atm of pressure without undergoing permanent deformation.

18. A method comprising:
providing an x-ray imaging system radiation source within a submersible, hollow, closed container that is configured to withstand at least 10 atmospheric pressure (atm) and hence to withstand being submerged at least 100 meters (m) in a liquid without undergoing permanent deformation to thereby serve as a submersible x-ray imaging system radiation source;
submersing the submersible x-ray imaging system radiation source at least 100 m in a liquid and disposing the submersible, hollow, closed container within at least 0.5 m of a submersed object under inspection;
using the submersed submersible x-ray imaging system radiation source to selectively direct x-rays towards the submersed object under inspection.

19. The method of claim 18 wherein the submersed object under inspection comprises at least one of:
a deep water pipe;
a deep water pipe valve;
a deep water blowout preventer.

20. The method of claim 18 further comprising:
submersing x-ray detector components on a side of the object under inspection that is opposite the submersible x-ray imaging system radiation source to detect the x-rays.
